(19) United States
(12) Patent Application Publication
(10) Pub. No.: US 2003/0149571 A1
(43) Pub. Date: Aug. 7, 2003

(54) System and method for facilitating decision making in scenario development

(76) Inventors: Steve Francesco, South Orange, NJ (US); David Bridge, Sparta, NJ (US); Ganesh Nathan, Fairview Village, PA (US)

Correspondence Address: BAKER & BOTTS, 30 ROCKEFELLER PLAZA, NEW YORK, NY, 10112

(21) Appl. No.: 10/061,988

(22) Filed: Feb. 1, 2002

(51) Int. Cl. G06F 17/60

(52) U.S. Cl. 705/1

(57) ABSTRACT

A system and method for facilitating decision making in scenario development and providing for optimization of future scenarios depending upon predetermined factors is provided. Qualitative and quantitative factors are provided for establishing a model and providing results that can include one or more bubble charts and other displays. Upon review of the results one or more users can modify the factors that comprise the model and reconcile qualitative results against quantitative results. One or more alternative scenarios can be developed and reviewed by one or more users thereby facilitating the decision making process of choosing an optimal scenario.

### SPECIFICATION

Reference to Computer Program Listing Appendix

A computer program listing appendix is submitted with the United States Patent Office in a compact disc and is hereby incorporated by reference. A listing of files provided on the compact disk is provided as FIG. 18.

### FIELD OF THE INVENTION

The invention relates to a system and method for facilitating decision making in scenario development and providing for optimization of future scenarios depending upon predetermined factors. More specifically, the invention relates to a system and method implemented on a computer for facilitating decisions based on qualitative and quantitative factors providing reconciliation of results and displaying the results on one or more bubble charts.

### BACKGROUND OF THE INVENTION

Decisions that must be made within complex and multi-faceted endeavors, such as are often made in business, involve numerous factors having interrelationships that can change as they evolve from present to future. For example, how the future develops in a business scenario can depend on present and future interactions among individuals and various groups, such as business managers and employees of a given company and its competitors in an industry of suppliers, distributors, government regulators, trade and consumer media, purchasers, professionals, and end users or consumers. Similarly, business management decisions at a given point in time can impact a business in the future, such as how sales of a product may evolve over time. In the past, decision-making tools have been limited in their ability to incorporate qualitative factors, especially when the factors for consideration are difficult to define. Furthermore, since decisions are most often dependent upon the particular circumstances involved, specific strategies are usually inappropriate when applied to different circumstances, and general models provide little, if any, value to an analysis of a particular set of circumstances.

In a drug product scenario, for example, specific factors such as regulatory issues, intellectual property issues, and distribution channel issues—such as prescription or over-the-counter vs. non-prescription drug status—all have complex interdependent roles and consequences in a drug product's profitability and thus complicate decision making with regard to marketing and developing the drug product.

Furthermore, since certain scenarios such as product development and regulatory drug approval often take several years, decisions having long term consequences can be more effectively and efficiently made in the present in order to obtain the desired results in the future, or as the case may be, to maximize profit in a given product. Computer facilitated tools for forecasting and analysis of such complex interactions are generally very rigid and even where some flexibility or range of variables are provided there is little or no transparency of the analytic process providing the results.

Another aspect of scenario development is that each and every opportunity for a decision between two or more alternatives made in the present can create as many future possible scenarios. Even a decision not to act can be a nexus for diverging alternative scenarios where an event might otherwise trigger action. Each subsequent decision at an opportunity made along a scenario path can likewise create additional branching scenarios. Even a scenario with but a few decision points can create a complex tree of branching scenarios. Existing computer assisted methods of analysis are fairly rigid in their approach to branching scenarios. Those that do provide some flexibility, provide insufficient transparency and thus a computer assisted development tool is needed that provides a user or users with the ability to perform analysis of branching scenarios.

Another aspect of decision-making processes that has been inadequately addressed has been the incorporation of qualitative data into a model in a manner that appreciates the uncertain nature of qualitative data. It is a problem inherent to qualitative measures to provide a relative scale for reducing otherwise unquantifiable qualitative factors into a quantitative format. Known techniques fail to provide satisfactory solutions for reconciling qualitative measures that may have been determined arbitrarily and without regard to a reference.

Existing computer-embodied methodologies of forecasting and scenario development also fail to provide a means for an individual assessing the results of an analysis incorporating qualitative data to appropriately distinguish the effects of such data on the forecast. Nor do they provide the means to review the assumptions underlying the incorporation of the data into the model. In addition, when individuals or groups of persons must consider long term future developments based upon present decisions, there is a need to be able to assess and communicate the potential scenarios and any underlying assumptions in order to make sound decisions and to question the incorporation of qualitative data. Furthermore, there is a need to facilitate consensus building among the individuals involved in the decision making process for providing better definition of the model by incorporating survey and consensus opinion on the value of factors for the model and the data to be applied therein. Accordingly, an improvement in a system and method for facilitating decision making in scenario development is provided which overcomes the above-stated deficiencies in the existing technology as further described herein.

### SUMMARY OF THE INVENTION

A system and method for facilitating decision making in scenario development is described herein as a analytic tool that an individual of skill in the art would be able to apply to the specific circumstances of a decision problem sought to be modeled. Although two specific embodiments are described below in detail, the system and method can be applied in numerous circumstances for modeling and analyzing a scenario to facilitate decision making. One such embodiment described concerns a model for pharmaceutical products and services that facilitate individuals and groups to collaborate in making profitable product development and marketing decisions. In a second alternative embodiment of the present invention, the system and method is applied to a decision model by a country club to decide which activities to offer its members in order to maximize the satisfaction level of its membership.

The system and method according to the invention provides a number of benefits and improvements over what has been done before. It provides means of integrating qualitative and quantitative data in a manner that facilitates decision making. It provides means to assess the impact of inherently unquantifiable factors on a model, to modify the structure and assumptions of the model accordingly, and to review the results of the modifications for comparison, and ultimately, for making a decision.

One aspect of the system and method is that it permits a user to anticipate and prepare for one or more possible future scenarios that can incorporate hypothetical triggers that can change underlying assumptions. The system and method permits a user to view resulting decision values calculated from developed models on bubble charts and, NPV charts among other things in order to evaluate the relative merits of scenarios being compared. It is a further object to provide a means to modify choices of qualitative factors, their values and weightings, and to automatically update the model in real-time so that a user can effectively consider the implications instantaneously in the resulting bubble charts. Accordingly, it is an objective of the present invention to provide a process that integrates qualitative and quantitative factors to provide at least two comparable scenarios reflecting a calculated decision value based upon a choice of qualitative factors.

It is a further object of the present invention to revisit past decisions, and re-assess assumptions and data in order to make revisions based on changing conditions.

Another object of the invention is to provide a group of individuals with a tool that promotes cooperation in strategic thinking, definition of a model, identification of relevant factors, establishment of qualitative and quantitative values and weightings. Such cooperation facilitates development of a model that better defines a particular scenario dependent on qualitative measures.

It is an object of the system and method to provide a representation of branching scenarios at a point of decision making.

It is another object of the invention to provide a system and method that permits a model that has been developed to be re-assessed at later times to include changes such as may be caused by specific events and to reflect those changes in one or more branching scenarios.

### BRIEF DESCRIPTION OF THE DRAWING

A more complete understanding of the present invention may be obtained from consideration of the following descriptions, in conjunction with the drawings, of which:

FIG. 1 is a flow chart showing an exemplary embodiment of a process for facilitating decision making according to the invention;

FIG. 2 is a diagram of a system for facilitating decision making according to the invention;

FIG. 3 is a diagram of an alternative embodiment of the process in FIG. 1 having additional functionality;

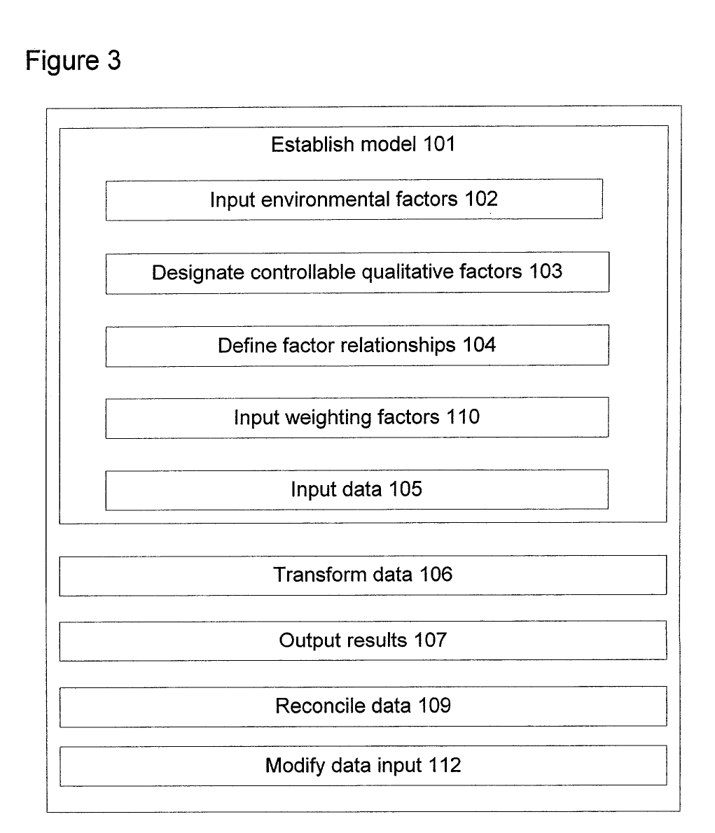

FIG. 4 is an example of a display output showing a reconciliation process prior to reconciliation;

FIG. 5 is an example of a display output showing a bubble chart prior to reconciliation;

FIG. 6 is an example of a display output showing a reconciliation process after qualitative factors have been reconciled with quantitative factors;

FIG. 7 is an example of a display output showing a bubble chart showing decision results after reconciliation;

FIG. 8 is an example of a display output showing forecasted revenues after several scenarios being developed;

FIG. 9 is a stylized overview of interconnected computer system network for an embodiment of the system in FIG. 1;

FIG. 10 is an example of a display output showing a graphical representation for a particular embodiment of the system shown in FIG. 1;

FIG. 11 is an example of a display output showing a graphical representation for a particular embodiment of the system shown in FIG. 1;

FIG. 12 is an example of a display output showing a graphical representation for a particular embodiment of the system shown in FIG. 1;

FIG. 13 is an example of a display output showing a graphical representation for a particular embodiment of the system shown in FIG. 1 showing a Net Present Value analysis for three product scenarios;

FIG. 14 is an example of a display output showing a graphical representation for a particular embodiment of the system shown in FIG. 1 of an evolution of a market and transfer of sales from one market to another market or over time;

FIG. 15 is an illustration of two sets of qualitative factors used to facilitate decision making for a particular embodiment of the system shown in FIG. 1;

FIG. 16 is an example of a display output showing a graphical representation for a particular embodiment of the system shown in FIG. 1;

FIG. 17 is an example of a display output showing a comparative summary of several tennis club scenarios; and

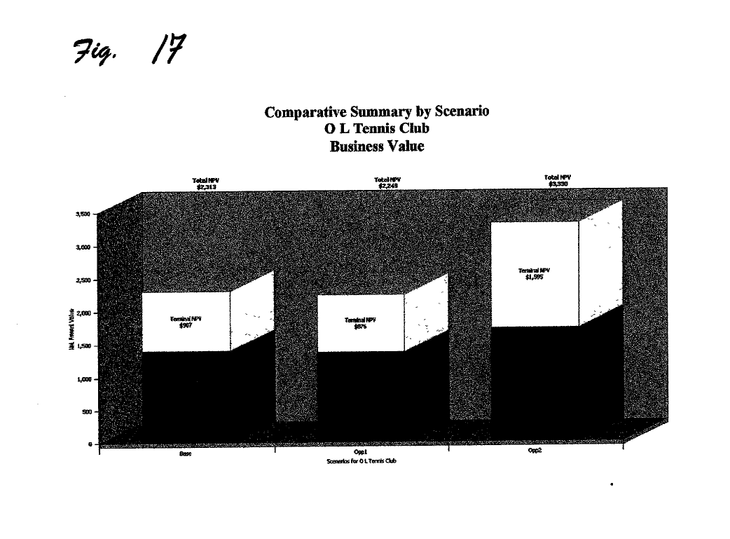

FIG. 18 is listing of computer software modules provide in ASCII format to the United States Patent Office, which modules originally included modules programmed in Visual Basic.

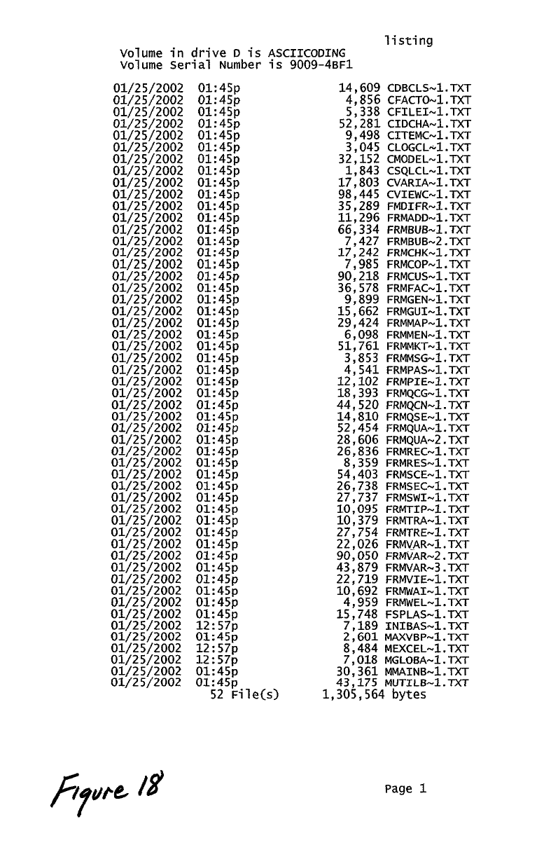

Throughout the figures, the same reference numerals and characters, unless otherwise stated, are used to denote like features, elements, components or portions of the illustrated embodiments. Moreover, while the subject invention will now be described in detail with reference to the figures, it is done so in connection with the illustrative embodiments. It is intended that changes and modifications can be made to the described embodiments without departing from the true scope and spirit of the subject invention as defined by the appended claims.

### DETAILED DESCRIPTION OF ILLUSTRATIVE EMBODIMENTS

A detailed description of the system and method for facilitating decision making is provided below for general applicability. In addition, two specific embodiments are provided as examples of the flexibility with which one of ordinary skill in the art may apply these teachings to address specific problems and to illustrate the benefits and improvements of the system and method over known computer facilitated solutions. In one embodiment of the present invention, the system and method is applied to the pharmaceutical industry. Specifically, a model describing alternative scenarios of converting prescription drugs to over-the-counter drugs is provided. The computer implemented system uses analytical models and spreadsheet formulas to show the relative results of such scenarios over a long-term time frame. The purpose of building this model comparing these scenarios is to choose a scenario that maximizes the value and contribution of a drug or product.

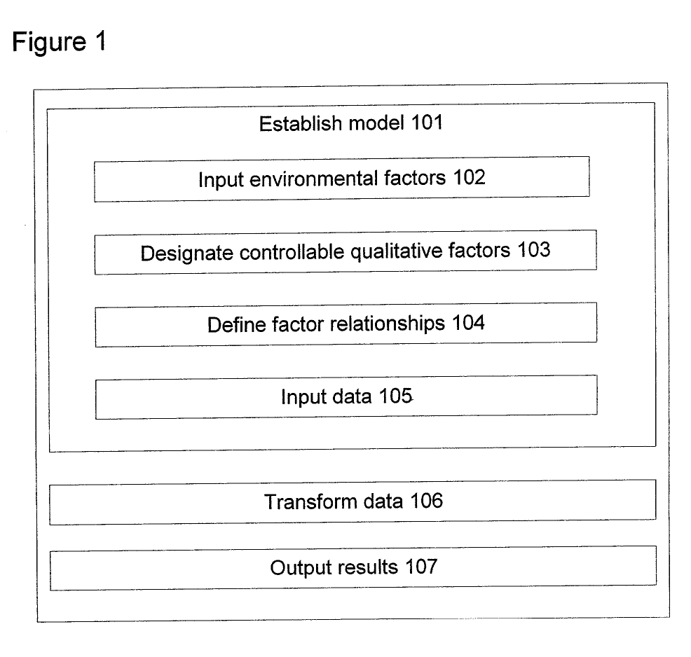

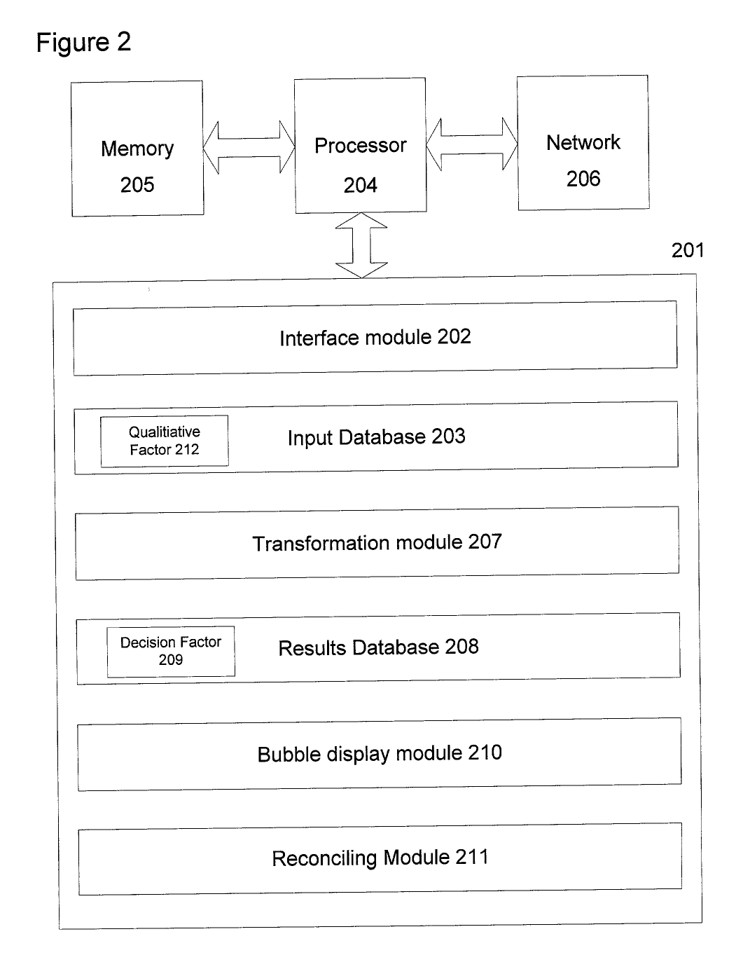

With regard to the following description, FIG. 1 provides a flow chart showing an exemplary embodiment of a process for facilitating decision making according to the invention. In addition, FIG. 2 is provided to show a diagram of a system for facilitating decision making according to the invention. FIGS. 1 and 2 are described together below for both the system according to the invention and the method according to the invention.

The system and method is an analytic tool programmed as software intended to be run by a computer and which operates on a model that is input 101 or programmed. The general analytic tool for the software can be programmed to be consistent with the system and method, and can be provided by one individual of skill in the art for general applicability. A specific embodiment adapted to a specific set of factors can be established 101 or developed by another individual of skill in the art. For example, the process of developing a scenario or set of scenarios by considering the qualitative aspects that may affect a scenario can require programming experience by a user developing a framework for a model. Alternatively, functions for developing a model can be provided by the software.

The system according to the invention is provided with programmed software 201. The programmed software 201 includes an interactive interface module 202 or graphical user interface that can be shown on a computer display to enable one or more users to input factors, weightings, their relationships, and their values for a particular model. As these are entered, they are stored in an input database 203, also called a qualitative database, which can be configured as a relational database.

The software 201 can be programmed to run on a processor 204 which cooperates with memory 205 to perform the instructions embodied in the software 201. The interface module 202 and other displays provided by the software 201 can be shown on a computer display (not shown) such as a CRT and can be transmitted to other machines, such as may be provided over a network 206, such as the Internet. The software 201 is further provided with an integrating or transforming module 207 which is software programmed to transform data in the input database 203 into transformed data to be stored in the results database 208, which is interchangeably referred to herein as the quantitative database. The transforming module 207 software specifically provides an output result called a decision factor 209. The decision factor 209 is transformed into a graphical representation by instructions in a bubble display module 210 also provided by the software 201. The software 201 can include a reconciling module 211 for reconciling data in the input database 203 and the results database 208.

The various modules of the software 201 can be integrated or provided independently. For example, the bubble display module 210 can consist at least partially of commercially available software. Similarly, instructions for programming the input database 203 and the results database 208 can also be provided in part by commercially available software.

One implementation of software embodying the system and method according to the invention is written in Visual Basic. However, other languages such as C++, Pascal, Java which are capable of utilizing a relational database can also be used. A relational database, such as SQL, can be used for converting two-dimensional computer data to multi-dimensional computer data. Object-oriented techniques are utilized to facilitate modular programming. In one embodiment of this invention, Visual Basic programming provides the basis of the model and integrates various third party utilities, the applicability of which one of skill in the art would readily appreciate. For example, a bubble display module 210 can utilize a charting function provided by Tidestone's First Impression Charts control. The results database 208 and portions of this transforming module 207 can be provided as a quantitative workbook utilizing Microsoft Access and that integrates a Tidestone Formula One Spreadsheet and Access based Jet Engine for various functionality. Other tables for storing data can be implemented in Videosoft Flex Grid and a Sheridan toolbar control can be used for menus and toolbars to form part of the interface module 202.

A database such as a relational database is provided to collect data items and organize them in a set of formally described tables from which data can be accessed or reassembled. In a relational database, this can be done without having to reorganize the database tables. Generally, a database can have tables with one or more data categories in columns, and can have rows containing data for the categories defined by the columns. When a relational database in created, a domain of possible data values and other constraints can be provided to limit the types of data values that can be entered.

A decision factor 209 can be one or more outcomes of a set of decisions that a user of the system and method seeks to evaluate. For example, a decision factor can represent a value of a product within a market for related products measured as a sum of characteristics that the product is desired to meet. The system and method calculates one or more decision values and displays the decision values on one or more bubble charts 215 according to specific qualitative and quantitative factors selected by a user.

An important aspect of the system and method is that at least one of the two selected factors for determining the location of a data point for displaying the decision factor on a bubble chart is a qualitative factor, or combination of qualitative factors, or a transformation of either. Providing at least one qualitative factor as a determination of a data point location on a chart is a part of the aspect of the system and method that permits a user with an important analytic tool. Furthermore, it permits a user to incorporate qualitative measures into a quantitative analysis, to interpret the results and make changes based on a comparison of those results, and then to interpret the changes in the qualitative inputs of the model. In addition, the system and method provides a user with the means to understand the effect of the changes from one scenario to another for ultimately making a decision.

As shown in FIG. 1, a set of processes for the method according to the invention provides steps for calculating and analyzing, a decision factor 209. The decision factor 209 represents a value to be calculated by the system and method according to relationships that are entered into a model created by a user. Accordingly, an interface module 202 or input means can provide initial data input screens for establishing a model 101. The initial steps of establishing a model 101 can be described as part of an initial input phase provided to create the structure of the model specifically adapted to the circumstances of the decision making problem. Alternatively, a model can be provided externally and simply downloaded as a program module for use by the system and method. Further below, a series of steps are described which constitute a second phase from which qualitative and quantitative data can be drawn. The input phase is also called the “Qualitative phase” even though it includes the input of both quantitative and qualitative factors since a majority of data at this point is usually qualitative. Choices of factors and their inter-relationships define a format for the results database 208 created in a second phase, called “Quantitative phase”. The quantitative phase has quantified factors received from the input phase and after a process of transforming data as the scenario move from present to future. Thus, as a model may require data for time periods further into the future, the model may become more dependent upon the initial qualitative data and thus exemplify the importance of an analysis of qualitative factors and related assumptions.

As part of an initial input phase of establishing a model 101, a specific step can be provided wherein environmental factors that are relevant to a decision factor are identified and incorporated 102 into the model so that a model describing and comparing potential scenarios can be developed. Environmental factors can include quantitative and qualitative factors that a user expects to be incorporated into the decision factor. Some of the environmental variables can be controlled and other environmental factors can be of types that cannot be controlled. For example, color of a product can be controlled, whereas an inflation rate may be deemed uncontrollable. A list of potential environmental factors can be drawn from generally accepted factors in the field relevant to the scenarios being developed, as well as an individuals knowledge and experience, and can also be drawn from a group of individuals by consensus or survey. For example, in the pharmaceutical embodiment described below, input factors have been generally divided into groups including markets, companies and scenarios. These factors in turn can be provided with one or more factors, being either qualitative or quantitative in nature. For example, a number of companies can have one or more products each, which factors can be represented by its own matrix in the relational database.

Another part of establishing a model is to designate or choose 103 which of those environmental factors are controllable qualitative factors that the user desires to analyze through the system and method according to the invention. A user chooses controllable qualitative factors on the basis that they are expected to be most important or which substantially affect the decision factor. These qualitative factors later receive much focus by the analytic tools provided by the system and method. Such focus is important because these factors are controllable and qualitative in nature. The system and method provides means to facilitate analysis of these factors and resulting decision values also by providing means to compare the qualitative factors to corresponding quantitative factors. Controllable quantitative factors can be identified by individuals of skill in the art according to their knowledge and experience and can be determined from group consensus or survey on the same such basis. Thus, a part of defining environmental factors is designating the factors as being either qualitative or quantitative in nature through the interface means for establishing such instructions in computer software.

Qualitative factors are factors that are qualitative in nature as opposed to being inherently quantifiable. As defined herein, qualitative and quantitative factors are distinguishable from like terms used in the chemical arts. In comparison to quantitative factors, qualitative factors describe a quality or characteristic of something, but unlike quantitative factors, they are difficult to reduce to a measurement. Usually, their incompatibility with measurement is because the degree or magnitude of a qualitative factor is often subjective and can depend upon human perception and or experience to provide a measurement that may not have a relative reference against which to compare its magnitude. Typically, qualitative measures cannot be reduced to a consistent, reliable quantitative measure by a measurement apparatus or methodology. This is distinguishable from quantitative factors, which can provide consistent results when the same characteristic is measured by the measurement method or apparatus. Such qualitative measures can require well-reasoned judgment, and can be based upon “soft” intuition or by consensus. Examples of qualitative factors include: the morale of a sales force; aesthetic appearance of a product; a customer's satisfaction; utility of a product or process; among other things. Quantitative data can often be based upon historical data and reconciled with an outside source such as number of products sold, total yearly revenue, percentage market share by sales, among others. Despite their inherently uncertain nature, qualitative factors can be critical to an analysis.

As part of the input phase and process of establishing the model 101, additional environmental factors, such as switch factors, can be established to provide a variable indicating one or more switch events having a material effect upon characteristics of other variables according to time period, and thus cause a branching of scenarios. Switch events are those which change the dynamics of the model or the relationship among factors and provide alternative scenarios. Examples of switch events include: patent term expiration, product recalls, or sudden shocks to the environment or market, such as the World Trade Center Tragedy. As another example, in the pharmaceutical model, a switch event can indicate a period of time when a prescription drug is converted to an over-the-counter form. After the switch event, the outcomes can be represented by two separate and combined scenarios in the model. Examples of major market impact factors for the pharmaceutical model can include: core prescription base converted to over-the-counter; competitor prescription base converted to over-the-counter; plus/minus from related prescription and over-the-counter markets; cannibalization with dual status; non-treaters and under-treaters; loss patient/user days; and, private label/branded generics.

Once a list of factors have been identified and entered into the qualitative database 203, the process provides for inputting data 105 attributed to the factors. This can be accomplished through the interface module 202. In addition, the method and system can permit a user to apply weightings 110 to the factors, which can also be done through the interface module 202. Weighting permits a user to ascribe to a factor a level of the importance of the factor relative to one or more of the other environmental factors. The value of a weighting can depend on the particular circumstances of the model and can be expressed as a percentage when compared against a limited number of like factors in a category. Such circumstances can be particular to the industry or category of a product involved and can be determined from the knowledge and experience of one more users. In addition, the weighting can be provided to change over a period of time according to the expectations of the user building the model. In addition, a scoring can be applied to factors to evaluate certain factors against other weighted factors or as a means of providing a ranking in an open category of factors.

As part of the step of establishing a model 101, an embodiment of the system and method provides an transforming module 207 to define factor relationships 104. A user defines factor relationships 104 by formulating equations or relationships among the factors, their weightings and their values and by entering these relationships in the model. In one embodiment, these are provided as equations coded into quantitative worksheet or spreadsheet provided as the quantitative database 208. The process of defining the factor relationships 104 can be provided independent of other processes or it can be provided as part of the input process of establishing the model 101 or as part of the quantitative phase before the process of transforming the data 105. Relationships among factors can be created through formulas, equations or calculations that depend on the factors and the unique characteristics of the situation which, when taken as a whole, define the structure of the scenario being modeled. Through these programmed rules and logic, a user can adjust the relationships between factors which are output as results 107 for several scenarios to be stored in the quantitative database 208.

In addition, the system and method provides a process for transforming 106 the qualitative and quantitative data by the transforming module 207 and stored in the qualitative database 203 during the input phase. Data that is transformed is saved or “pushed” in the quantitative database 208 or spreadsheet. The transformation process 106 provides instructions for quantifying the data entered in the qualitative database 203 according to the rules and equations defined earlier. Qualitative and quantitative factors are entered and transformed so that data representing the factors can be integrated with the system and so that the factors are used consistently. Processes for transformations of data 106 can include processes that transform qualitative type data to quantitative data and from quantitative to qualitative. One example of a transformation of a qualitative factor into quantitative data can be: if data representing whether a product is first-to-market, then a market share advantage factor over a second-to-market product could be attributed a value of +30%. An example of a transformation of quantitative data into a qualitative factor can be: if market share exceeds 60%, then the product is attributed a dominant market position.

The results or quantitative database 208 itself can include dynamic formulas or equations for performing calculations on the analytical data, which formulas are particular to the circumstances being modeled. As mentioned, these can alternatively be provided as part of the transformation process 106. By providing dynamic relationships in the results database 208 however, it is possible to change a few data items from the input phase without having to repeat a transformation process for all factors. In addition, it has the benefit of avoiding the added complexity of an input specific integration function designed to address only data items that have been altered after a previous transformation. For example, some of the formulas for the transformation process 106 can be provided on a computer spreadsheet having predefined formulas dependent upon the data pushed onto the spreadsheet such that quantitative and qualitative data entered by input or modification immediately provide output calculations reflected as the results database 208. By providing some of these processes using spreadsheets, the system permits real-time updating of the results database based on user interaction, and permits creation of alternative scenarios for comparison reflecting user modifications after an analysis.

As one result of the transformation step 106, the system and method according to the invention can calculate one or more values for the decision factor 209 or factors based upon calculations resulting from the relationships defining the model and outputs 107 the results to the results database 208. Alternatively, the calculations for the decision factor 209 can be done by the dynamic functions of the results or quantitative database 208. For example, the decision factor 209 can be calculated as a net present value (NPV) representing a stream of income attributed to a marketing decision and can be expressed in a bubble chart, a bar chart or a combination of both. Decision values are a central focus of the analytic tools provided by the system. Values are preferably represented as the size of one or more bubbles shown in each scenario and positioned on at least one bubble chart by the processes of the bubble display module 210. One or more sets of decision values can be stored as part of the results database 208 or as a separate modified database. Decision values reflecting changes in a model can be compared to decision values before the modification in combination of bubble charts and NPV bar graphs. Furthermore, other analytic measures such as a terminal value can be used for comparison in a quantitative analysis at the user's discretion. Other measures can be used for the decision factor 209 and can be either quantitative or qualitative in nature. Decision factors 209 and other factors and calculations can be shown on a variety of graphs besides bubble graphs to further facilitate decision making.

Bubble charts are a preferred means for displaying decision values by the processes of the bubble display module 210. Bubble charts are a type of two-dimensional chart that can have an X and a Y axis and are typically used to compare sets of three values. Each data point has two values which positions the bubble relative to the region on the graph. The size of the bubble represents the value of the decision factor. Additional factors can be represented by color or depth of a bubble. Unlike most charts, having two variables, bubble charts have three. To plot this on a chart, one uses the size of the bubbles as a visual indicator of a decision value. The larger the bubble, the greater the decision value.

In one embodiment of the bubble display module 210 bubble charts are provided as showing decision values having greater benefit or utility as being positioned in the upper right comer of the graph. Low values are shown in the lower left comer. In addition, it is an important aspect for facilitating an analysis involving qualitative factors that a bubble chart be provided with at least one qualitative factor represented on one of the axes of the graph. The use of one or more bubble charts to output results 107 provides a tool for a user to visualize data over a period of time in the context of the specific set of controllable qualitative factors chosen by the user. Bubble graphs enhance comprehension of the evolution of scenarios and assist in the appreciation of the consequences of decisions, and provide an easy and intuitive way to express a set of relationships. Part of an analysis of a model that has been established and pushed onto the quantitative database is to identify why a bubble is or is not at a position expected, such as an upper right hand comer of a chart when an optimal position is expected. This analysis could include reviewing the factors, their weightings and scorings, as well as underlying data to determine where inaccuracies may exist. Alternatively, such an analysis can confirm a result that is contradictory to expectations.

The system is further provided to dynamically change the factors and weightings such as processes for modifying data input 112 which can be provided as part of or in addition to the interface module 202. In combination with bubble charts, processes for modifying and reconciling data are provided by the system and method that stimulate users to re-assess the value and choice of qualitative factors. These processes assist users to consider new ideas, issues and solutions along the path of future courses of action that can impact and change the future evolution of the scenarios. The bubble charts are preferably provided having only qualitative measures on at least one of the two axes of the chart. It is important to separate the effects of quantitative measures from the qualitative input to facilitate a user's appreciation of the choice of factors that lead to the visualized results and can thereby permit a user to understand the effect of qualitative factors and weights within each scenario.

The processes provided in the output display module 210 to output results can be provided with animation processes wherein a scenario spanning a period of time can be animated in a bubble chart according to the time-sequence of the scenario. Time sequence visual animation of the qualitative and quantitative analysis facilitates comprehension of the various potential future directions of the market, the competitive products and the company products. This, in turn, stimulates thought of future courses of action that can impact and change the future evolution of the market. When animated, data points showing decision values may change size and position to reflect changing factors over a period of time. Bubble charts can reflect changes made to the model dynamically by updating changes made by the processes for modifying data input 112.

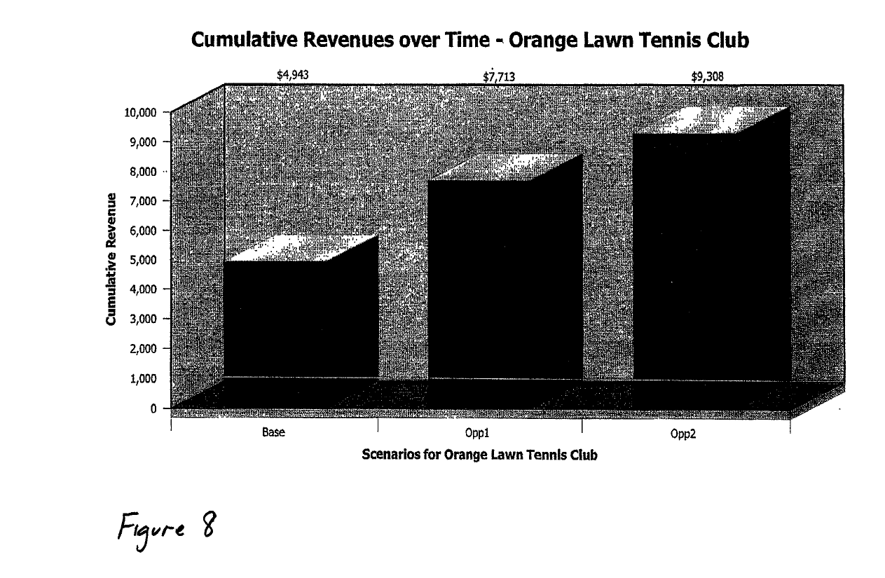

Thus, since the bubble charts are dynamic, not static, the models created by a user are dynamically customizable for each user, based on the defined desired variables. In addition, quantitative summary charts are also dynamic to reflect changes made. Whether data is expressed as net present values or some other measure such as cumulative revenue over time, the use of two databases to modify the quantitative data in a way that is similar to the qualitative data changes a quantitative chart as shown in FIG. 8 in real time. Finally, changing both the qualitative and qualitative values changes both the bubbles and the quantitative bar charts simultaneously.

As part of a quantitative phase, a processes for reconciling data 109 can be provided wherein a user can reconcile quantitative data in the results database 208 with comparable qualitative data in the input database 203. The reconciliation processes 109 are provided by a reconciling module 210 to compare like quantitative and qualitative factors. Variable pairs can be set during the initial phase in defining the factors. Based on knowledge and experience, and taken in light of a user's comparison with the quantitative data during a reconciling process 109, a user can assess whether any of the inputs provided in the process for establishing the model 101 need to be adjusted. For example, quantitative data representing market share measured by factors such as sales of a product and sales of all products with a market may provide a different result than a qualitative factor representing market share based on user perceptions. Similarly, the reconciliation process can ensure that the qualitative and quantitative results are consistent among comparable factors, such as sales, market size, and market growth.

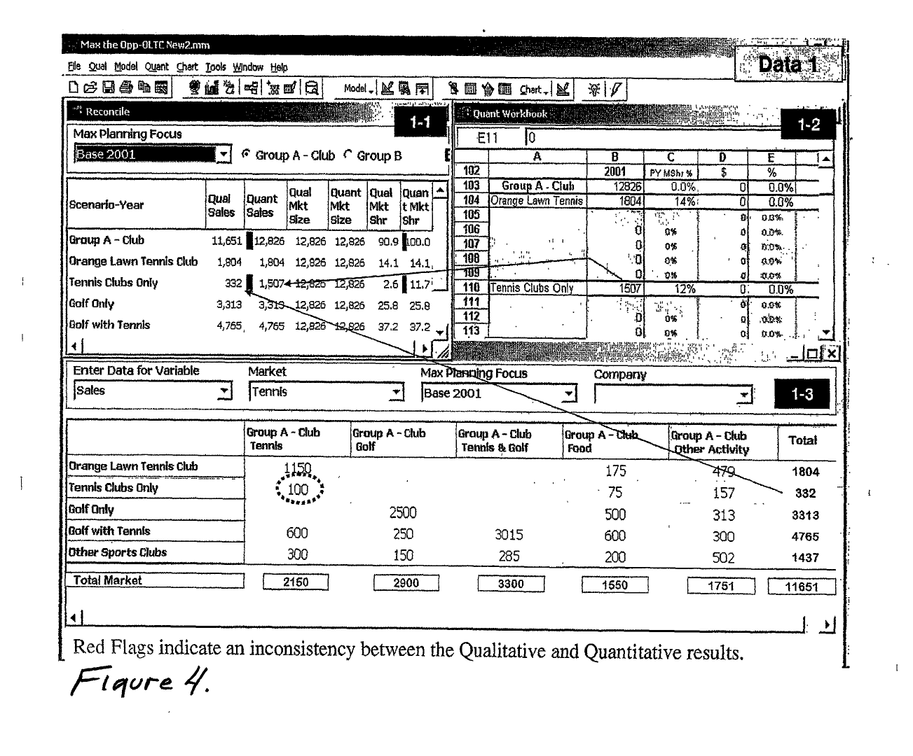

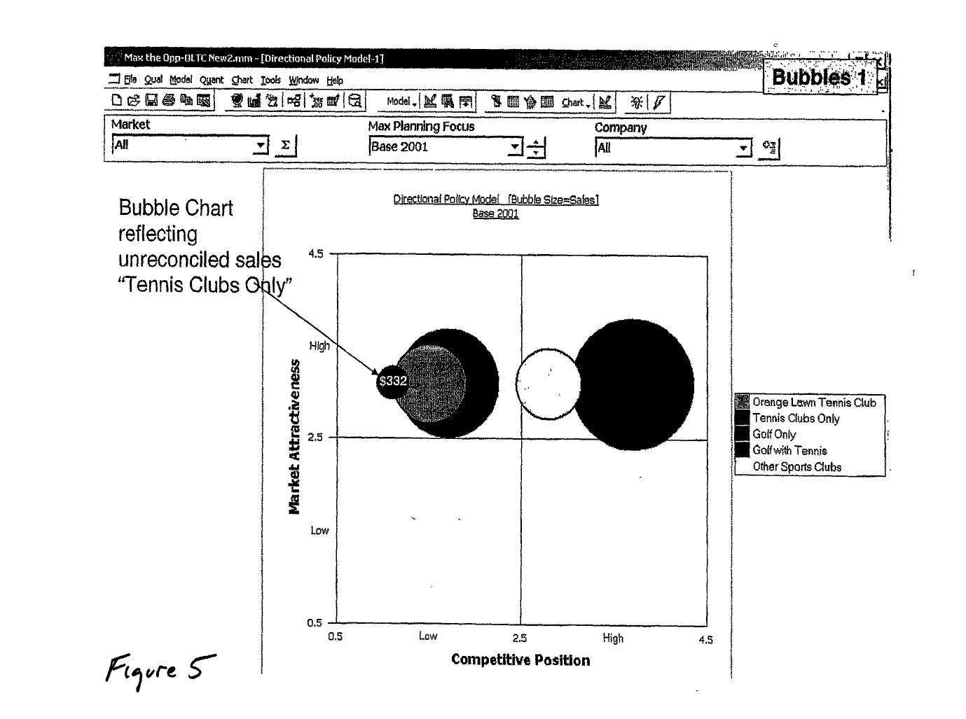

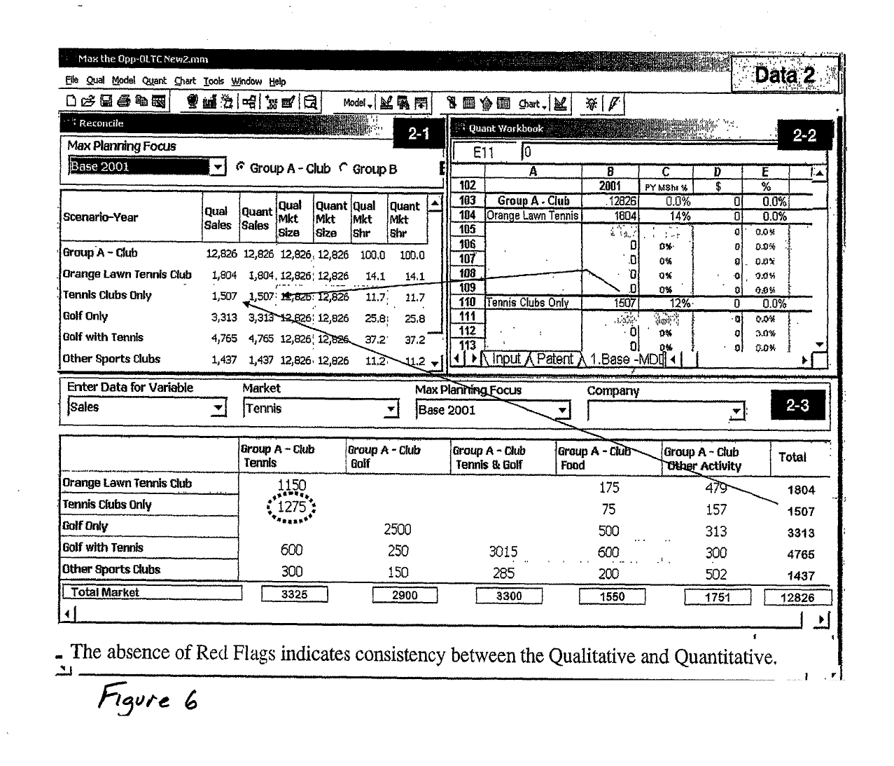

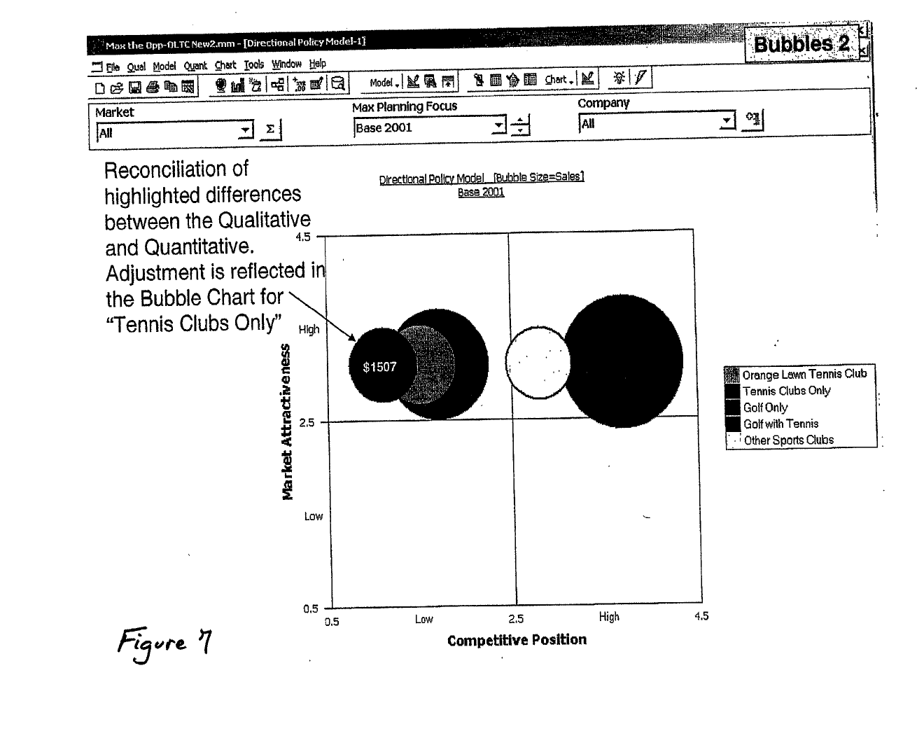

The reconciling process 110 also provides “red flags” when the qualitative and quantitative numbers are inconsistent. When the appropriate corrections are made, the red flags disappear. It is the ability to easily reconcile these two data sources that creates the dynamic change in bubble size and location after a red flag has indicated inconsistency. As shown in FIG. 4, the chart indicates an inconsistency in qualitative sales estimates for Tennis Clubs Only of $332 and $1507, respectively. This, in turn, indicates an inconsistency in the market share of that segment. The qualitative market is 2.6% and the quantitative share is 11.7%. Red flags indicate the Tennis Clubs Only sales shares are inconsistent. As shown in FIG. 5, a bubble chart, the Tennis Only bubble ($332) is quite small and distanced from the other types of clubs, representative of its lower values. Once the sales/share inconsistency is corrected, the “red flags” are eliminated and the bubble in question changes. As shown in FIG. 6, a chart shows the reconciled values, eliminating the red flags. Similarly in FIG. 7, a corresponding bubble chart reveals a larger Tennis Only bubble ($1507) as well as a closer proximity to the other elements on the chart. Since reconciliation attempts to compare factors derived by different processes, reconciliation can be subjective and thus benefits from comparing changes from one scenario to another and by obtaining consensus opinion in this process.

In addition, other types of charts may be used to analyze the results of a model and for determining the accuracy of the choice of factors, and weightings among other things. A directional policy model, for example, is a multi-factor approach incorporating the share/growth axes and allows numerous choices of axes to be compared (sales versus customer satisfaction, market growth versus cost of entry, etc). A Boston matrix can be used to simply model measures of growth and share of market. A “Porter 5” model can provide a “big picture” approach that shows the structure of industries and complex opportunities and provide a means to assess through its factors whether there is an attractive opportunity by taking a particular opportunity. A life cycle model plots the stage of the lifecycle of a product or industry against a perceived competitive strength. Another model that can be used is a risk-return model that compares a financial return against a perceived risk. Risk can be defined in many ways based upon the sources of risk and their likelihood of occurrence.

The interface module 202 provides screens for establishing the model 101 as well as screens for a view of the qualitative input screen, the quantitative or integrated database, the reconciliations screen and/or an output bubble chart. Multiple such screens can be shown at once. By providing multiple screens, the system provides a user the maximum benefit of the transparency of the model such that a user can immediately see and appreciate the impact of changes to the model and how decisions affect the outcome of one or more scenarios.

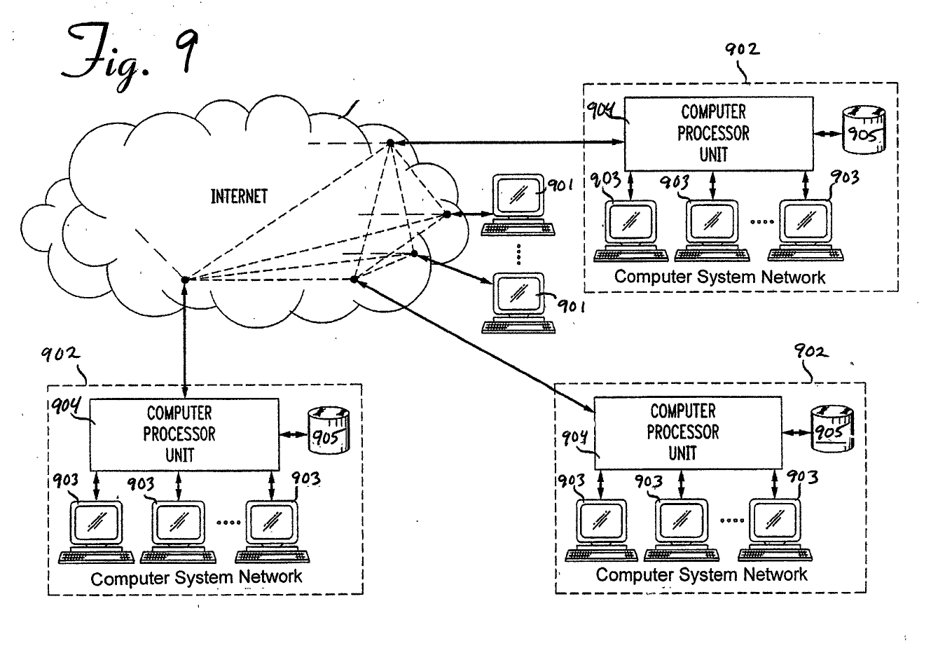

As shown in FIG. 9, the system and method according to the invention can be provided on either a standalone computer or on a computer in a networked environment 901. A networked environment 901 can permit one or more additional users to interact at one or more stages of the development of a model. A networked environment is two or more separate computers 901 that are either linked on a peer-to-peer basis or as a central server network 902 linked to at least one client terminal 903. A link between the computers does not have to be a physical link-it can be a link via a modem, or any other method of communicating between computing and communications devices, including hard-wire connections, radio communications, infrared communications, optical communications, and the like.

Each central server network 902 is provided with a central processor unit 903, for running the modules of the software 201, and which is coupled to corresponding local memory storage unit 905, and local client terminals 903. Each central server network 902 can be selectively coupled to one or more other central server network 902 or to stand alone computers 901 in a network 206 such as the Internet.

By utilizing the system and method according to the invention in a networked environment, multiple individuals at multiple locations around the world can simultaneously participate in the analytic process. Multiple individuals can provide consensus building information, indicate choice of factors for the analysis, or simply input data or view the results of an analysis, among other things. The networked system can be provided to solicit, record, track and display the input decisions from several individuals at various locations. Alternatively, the contributions by one or more individuals of a group can be made by survey, or can be made anonymously. Similarly, a network of users can contribute to decisions related to the choice of qualitative data for environmental factors or relationships to be included in a model. In addition, since at all points in the process of establishing a model 101, factors, weightings and data can be recorded and displayed, the input of users can be identified as being in agreement or disagreement with other users' choices of such inputs in the network. This in turn can generate multi-individual, multi-site and multi-discipline collaborative discussion on business issues. By providing a collaborative process, the system and method facilitates information gathering, knowledge sharing, idea generation and evaluation, and provides assessment and generation of new strategic options for decision making.

Application to a Pharmaceutical Market

As one specific application of the system and method according to the invention, a model has been developed in a software program to facilitate decision making for a particular set of scenarios in the pharmaceutical market. The decision factor for this application is one that assists a user in choosing a scheme that “maximizes” the profit of a pharmaceutical company's product over a period of time. Specifically, the model considers functional factors including whether the drug product is sold as over-the-counter or is provided as leaving the prescription market to become an over-the-counter version of the drug. The model addresses known contingencies of uncertainty, timing, and competitive activity and provides a method of analysis that is flexible, and can change over time as circumstances change. Below is provided a description of the factors that would be incorporated into such a model and how these factors interrelate to form the structure of the model.

In this model, the eventual plan to be executed includes the switch of new dosage form with a reduced dosage strength in the new packaging. Assuming as an environmental factor that a company's decision to switch to a lower dosage product to create dual prescription/over-the-counter status for a drug product could require 43-92 months from the time the company's management decides to pursue such a decision until the product with approved labeling can be shipped into the market for one over-the-counter product. The model also assumes as an environmental factor that the scenario involves a patented drug having but a few years of remaining patent protection. As a result, the remaining time of patent protection is a very important factor to a decision to switch the drug and to switch the drug prior to its patent expiration.

Some quantitative factors can include sales, market size, market growth and market share. Qualitative factors can include competitive position, product quality, reputation, market share, price, distribution, market attractiveness, market size, market growth, profitability, capital required, and competition. Market share, as a quantitative factor, can be calculated based upon quantitative date. As a qualitative factor, it can attributed a value among a ranges and eventually revisited after the integration and reconciliation phase and have its weighing or scoring adjusted as necessary. Similarly, market size and market growth, as qualitative factors, can be compared after integration and revisited and reconciliation.

As another example of factors and how they can interrelate, a company's effort to switch to an over the counter drug will be competing for resources that could be applied to the prescription development of the company's next blockbuster prescription drug. If a model is designed to provide a decision factor for maximizing profit over sales of all products by the company, another factor would be the resources applied to prescription product launch which would be provided with formulas in the qualitative phase such that resources applied to a prescription product launch would be approximately inversely proportional to resources applied to a switch. Since lead time can be a significant barrier to a timely market entry in the pharmaceutical scenario, it is afforded a very high weighting relative to other timing factors. Indeed, it can be provided as an absolute event.

In some cases it would be appropriate to compare the relative marketability of the competing products. While the fundamental pharmacology of a molecule (drug) cannot be changed easily, there are a number of variable product features that can be added or modified to create meaningful competitive advantages to consumers in an over-the-counter product. With medications, there are basically three types of product benefits: efficacy, safety and ease of use. It is possible to provide specific weighting rules for these factors. Generally, in terms of importance to the consumer, efficacy is by far the most important. If the drug does not work, then its safety or ease of use will not be relevant factors. Therefore, efficacy receives a high weighting.

If there is no category differentiation among products according to efficacy, then safety or ease of use can become a major point of distinction and receive higher weightings accordingly. The values inserted into the model for safety, or ease of use, and consumer perception can be based on survey results or by consensus of individuals knowledgeable in the industry, among other things. Furthermore, since the system and method provide means for sharing the factors and the bubble analysis, the factors for the model can be shared among users in a network in a quickly and easily understood format. Accordingly, discussion and consensus opinion for defining these factors to the end of obtaining a meaningful decision result is facilitated.

Another important set of factors that defines a structure for a model include those market forces that affect the profitability of a market. For example, a list of companies comprising the over-the-counter competition, both in terms of existing over-the-counter products and of other prescription products that are likely to switch to over-the-counter provides a factor that can affect the profitability of a switch. For example, in the H2 antagonist switch (a particular model for pharmaceuticals), the competitive set can include over-the-counter antacids, prescription H2 antagonists and prescription Carafate (sucralfate). Potential alternatives to a product are screened and reduced down to a manageable number.

Use of other factors such as “appropriateness” can be provided for over-the-counter therapy drugs as well as a factor for commercial feasibility. For example, an appropriateness can be whether it is reasonable to consider getting a product to the public without the intervention or involvement of a doctor. A factor for advantages or disadvantages can be provided to follow a ranking according to importance to the consumer. Product efficacy as a factor is likely weighted as being one of the most important factors. A factor that categorizes a drug as being faster acting is appropriate for a portion of the market drugs that address acute conditions like headache, whereas a factor that describes a drug longer lasting relief would be more appropriate for drugs that address protracted or chronic conditions like muscular pain.

Another factor includes the current differences in competitive products. In a biochemical application, for a switch to be successful, it must meet current category requirements, such as efficacy. Ideally, a successful switch should be better than the current over-the-counter products already available, and have few or none of their disadvantages. The degree of this efficacy can be expressed as a factor. Similarly, an important factor can be whether the switch drug overcomes a current product disadvantage, such as was the case of acetaminophen analgesics that had no aspirin side effects.

As another example, over-the-counter Pepcid™ addresses both a current category factor of being fast acting and addresses its disadvantage expressed in a factor as being slow acting by having the qualitative factor of including a prophylactic claim to explain away the problem. A consumer doesn't mind if the drug is slow acting if it prevents a problem from occurring. Once competitive on this key consumer benefit, Pepcid's other advantages of being perceived as a more efficacious prescription-based medication and being a pleasant-to-take swallowable tablet medication could be elevated into consideration as a competitive advantage as reflected by a weighting associated with this product.

Market research may be needed, to identify less obvious features for incorporation into a model. For example, research could indicate whether consumers perceive a product competitively unique and meaningful advantages.

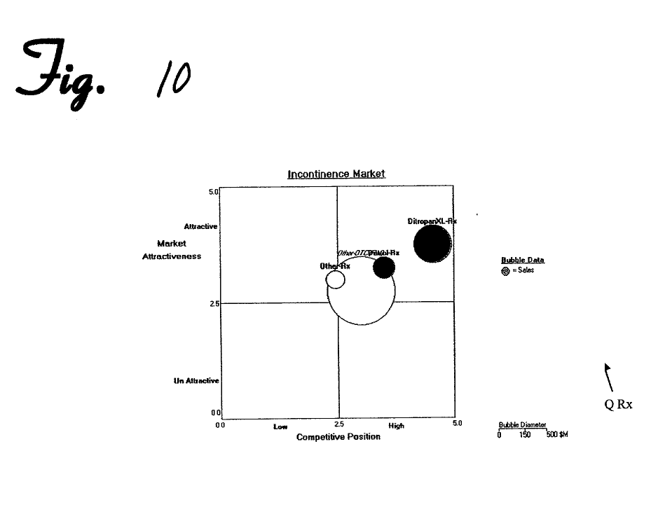

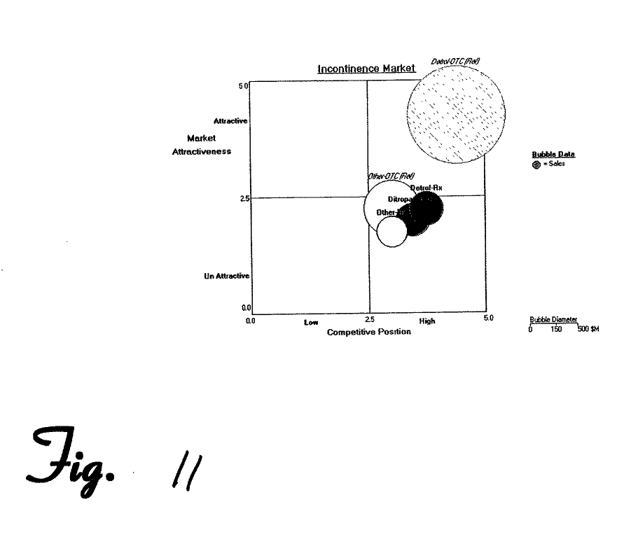

Referring to FIG. 10, there is shown a graphical representation of the market for incontinence drugs for year 2000, in which the over-the-counter market is provided as a reference point. Referring to FIG. 11, there is shown a graphical representation of the market for incontinence drugs for year 2010, where product R switches to dual status (over-the-counter and prescription) in 2005 and the status of product Q remains as a prescription product.

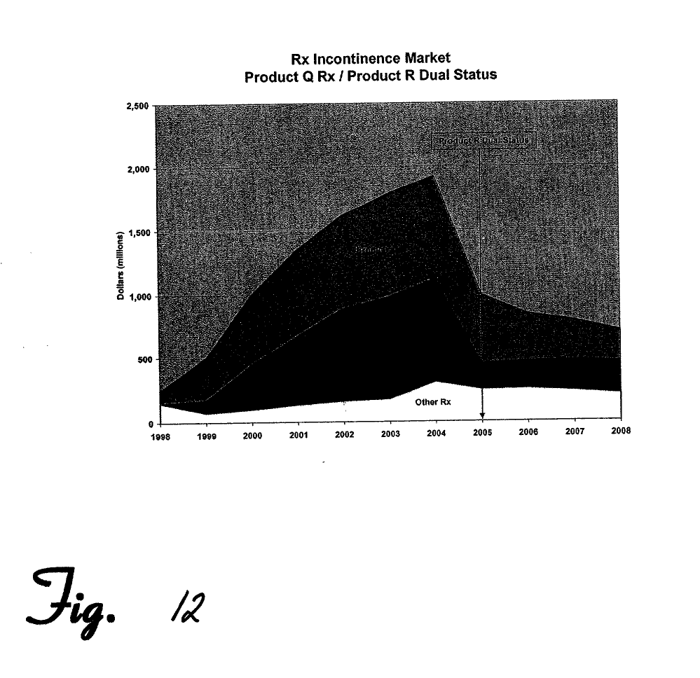

Referring to FIG. 12, there is shown a graphical representation showing that the prescription market sales have dropped off starting with the first switch from prescription to over-the-counter. By having a dual status strategy, product R offers a significant alternative to the existing over-the-counter remedies.

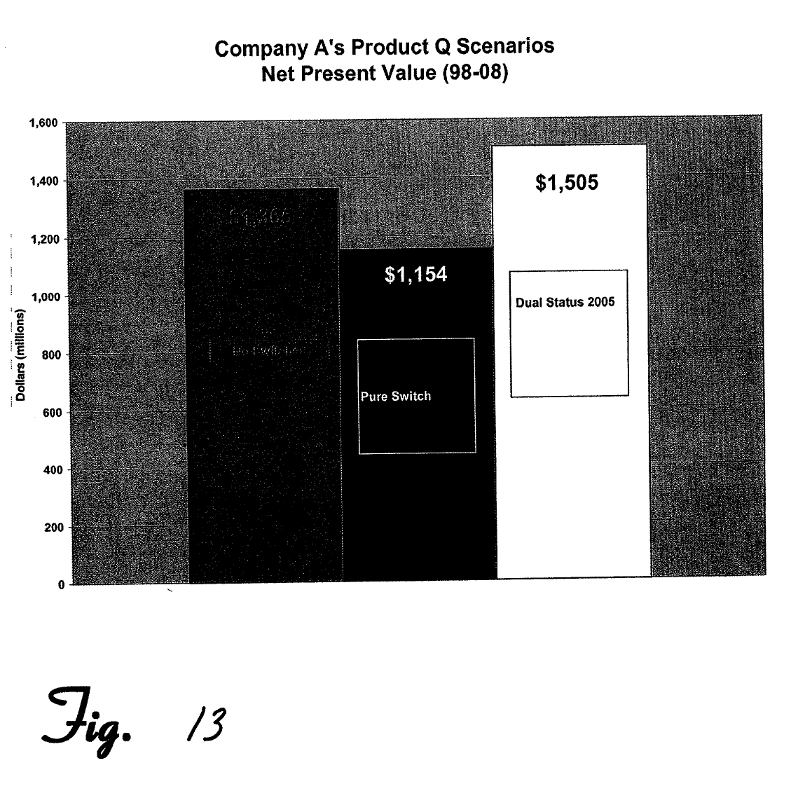

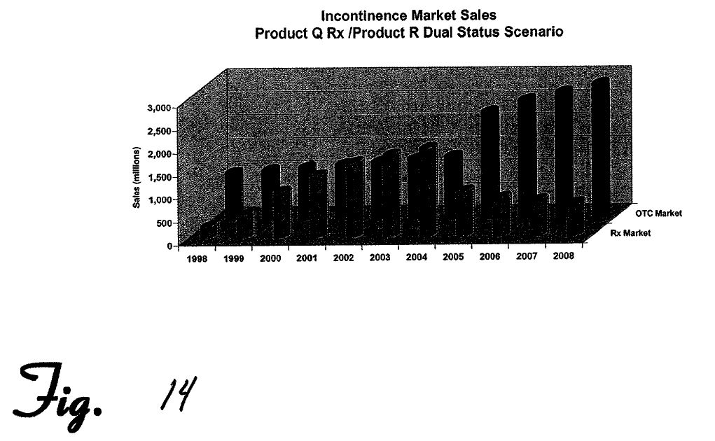

Referring to FIG. 13, there is shown a graphical representation of net present value for three product scenarios. It can be seen that during the time frame of 2000-2010 the over-the-counter drug market becomes larger than the prescription drug market. Both markets are close in size in 2004, and the over-the-counter drug market increases at the expense of the prescription market after Product R switches to dual status in 2005. Referring to FIG. 14, there is shown a graphical comparison of competitive product sales and overall market evolution over the timeframe. Based on the assumptions used in this exercise, the dual status scenario provides the best value for Product Q.

Application to a Sports Club

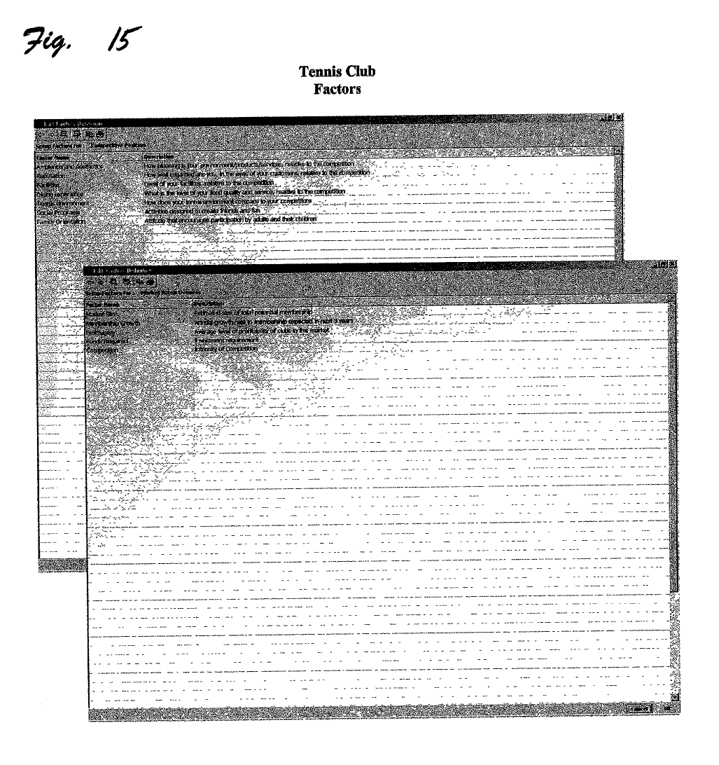

In this model, an established tennis club is seeking to increase its membership while improving satisfaction of its members. A qualitative assessment is made to determine what factors are to be included in the model. For example, strengths and weaknesses of the tennis club can be provided to compare it to other clubs which compete for the same membership. New products and services were considered as a factor for consideration. FIG. 15 shows some important qualitative factors which include ambiance and aesthetics, reputation, facilities, dining experience, tennis environment, social programs and family orientation. A comparison was set up between this club and other clubs in 1960, 2000 (FIG. 8) and what they wanted to be in 2003 and 2005.

In addition, quantitative factors are entered into the model that describe market size, membership costs, profitability, and expected costs for improvements, for example. Other environmental factors such as total potential local market membership, total membership dollars available to the local market, market share of competitors and anticipated market growth can also be provided to define the structure of the model.

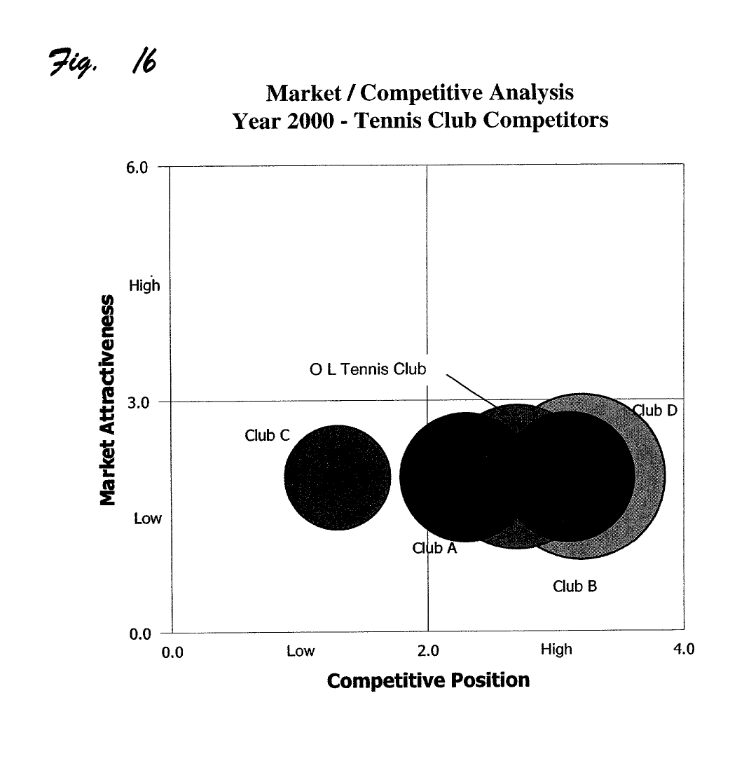

After the factors and data are entered and the model structure defined, the quantitative decision portions are calculated by the integration function for each scenario. As shown in FIG. 16, a decision factor representing member satisfaction is shown in a bubble chart for several clubs.

As shown in FIGS. 4-8, the results of the analysis can be shown in several output screens, including the bubble chart that explicitly shows better decision value for an alternative scenario.

The invention has been described in connection with certain preferred embodiments. It will be appreciated that those skilled in the art can modify such embodiments without departing from the scope and spirit of the invention that is set forth in the appended claims. Accordingly, these descriptions are to be construed as illustrative only and are for the purpose of enabling those skilled in the art with the knowledge needed for carrying out the best mode of the invention. The exclusive use of all modifications and equivalents are reserved as covered by the present description and are felt to be within the scope of the appended claims.

We claim:

1. A computer usable medium comprising a computer program code which is configured to cause a processor to execute one or more functions comprising:
entering data and storing the data including at least one qualitative factor and at least one quantitative factor;
providing an interface for a user to establish a model based on the data;
transforming the data in accordance with the model and storing the results of the transformation, thereby calculating at least one decision value, wherein the at least one decision value is calculated using data including at least one qualitative factor;
providing an interface for a user to review the at least one decision value and to modify the model and the data including the at least one qualitative factor;
transforming the modified data including the at least one qualitative factor in accordance with the model and storing the modified results of the transformation, thereby calculating at least one alternative decision value, wherein the at least one alternative decision value is calculated using modified data including the at least one qualitative factor; and
providing an interface for a user to compare the at least one decision value and the at least one alternative decision value and to reconcile the at least qualitative factor and the at least one quantitative factor.

2. The computer usable medium comprising a computer program code according to claim 1 wherein the interface provide for a user to compare the at least one qualitative factors and the at least one alternative qualitative factor further comprises providing an interface for a user to display the at least one decision value and the at least one alternative decision value on at least one bubble chart.

3. The computer usable medium comprising a computer program code according to claim 1 which is configured to cause a processor to execute one or more functions further providing an interface for a user to display the at least one decision value and the at least one alternative decision value on at least one NPV chart.

4. The computer usable medium comprising a computer program code according to claim 1 which is configured to cause a processor to execute one or more functions wherein the at least one qualitative factor includes at least one controllable qualitative factor; and wherein the at least one decision value and the at least one alternative decision value reflect a transformation of the at least one controllable qualitative factor.

5. The computer usable medium comprising a computer program code according to claim 2 wherein the at least one bubble chart is a Cartesian type, wherein a first axis of the bubble chart represents a transformation of at least one controllable factor, and wherein the bubble chart displays at least one bubble having a size representing at least one decision value based on the transformation with the at least one controllable factor.

6. The computer usable medium comprising a computer program code according to claim 1 wherein the at least one qualitative factor includes at least one present qualitative value and at least one future qualitative value.

7. The computer usable medium comprising a computer program code according to claim 1 wherein transforming the data includes
integrating the data in accordance with the model; and
pushing the integrated data into a results portion of a database.

8. The computer usable medium comprising a computer program code according to claim 1 wherein data is stored in a relational database comprising a quantitative database, a qualitative database, and a modified database.

9. The computer usable medium comprising a computer program code according to claim 1 which is configured to cause a processor to execute one or more functions further comprising dynamically updating the results database upon modifications in the data and the model.

10. The computer usable medium comprising a computer program code according to claim 1 which is configured to cause a processor to execute one or more functions further providing an interface for a user to establish a model having factors including weighting factors, scoring factors and switch factors.

11. The computer usable medium comprising a computer program code according to claim 1 which is configured to cause a processor to execute one or more functions further comprising
providing an interface for a user to display the at least one decision value; and
animating changes in the decision value over a period of time.

12. The computer usable medium comprising a computer program code according to claim 1 which is configured to cause a processor to execute one or more functions further comprising
providing an interface for a user to display the at least one alternative decision value; and
animating changes in the alternative decision value over a period of time.

13. The computer usable medium comprising a computer program code according to claim 2 wherein the interface permits a user to activate the transforming functions.

14. The computer usable medium comprising a computer program code according to claim 2 wherein a bubble in the bubble chart is a point.

15. A computer usable medium comprising a computer program code which is configured to cause a processor to execute one or more functions comprising:
entering data and storing the data including at least one qualitative factor and at least one quantitative factor;
providing an interface for a user to establish a model based on the data;
transforming the data in accordance with the model and storing the results of the transformation, thereby calculating at least one decision value, wherein the at least one decision value is calculated using data including at least one qualitative factor;
providing an interface for a user to review the at least one decision value and to modify the model and the data including the at least one qualitative factor;
transforming the modified data including the at least one qualitative factor in accordance with the model and storing the modified results of the transformation, thereby calculating at least one alternative decision value, wherein the at least one alternative decision value is calculated using modified data including the at least one qualitative factor; and
providing an interface for a user to compare the at least one decision value and the at least one alternative decision value and to reconcile the at least qualitative factor and the at least one quantitative factor;
providing an interface for a user to communicate over the network;
receiving network data related to the model and storing the network data; and
collecting consensus information over the network for establishing which network data is incorporated into the model.

16. A software arrangement for facilitating decision-making analysis and for use with a computer comprising:
an input database means for storing data comprising at least one qualitative factor and at least one quantitative factor;
a results database means for storing results and at least one decision value;
an interface means for entering the data into the input database means and for establishing a model based on the data; and
transformation means for transforming the data in accordance with the model, for pushing the transformed data into the results database, thereby calculating the results and the at least one decision value, wherein the at least one decision value is calculated using data including at least one qualitative factor;
wherein the interface is further provided with means for reviewing the at least one decision value, means for modifying the model and the data including at least one qualitative factor, and means for reconciling the at least one qualitative factors and the at least one quantitative factor;
wherein the transformation means is further provided with means for updating an the results and at least one alternative decision value; and
wherein the interface is further provided with means for comparing the at least one decision value and the at least one alternative decision value.

17. The software arrangement for facilitating decision-making analysis according to claim 16 wherein the interface is further provided with means for displaying the at least one decision value and the at least one alternative decision value on at least one bubble chart.

18. The software arrangement for facilitating decision-making analysis according to claim 16 wherein the interface is further provided with means for displaying the at least one decision value and the at least one alternative decision value on at least one NPV chart.

19. The analytic decision-making and optimization system according to claim 17 wherein the at least one qualitative factor includes at least one controllable qualitative factor; and the at least one decision value and the at least one alternative decision value reflect a transformation of the at least one controllable qualitative factor.

20. The analytic decision-making and optimization system according to claim 17 wherein the at least one bubble chart is a Cartesian type, wherein a first axis of the bubble chart represents a transformation of at least one controllable factor, and wherein the bubble chart displays at least one bubble having a size representing at least one decision value based on the transformation with the at least one controllable factor.

21. The software arrangement for facilitating decision-making analysis according to claim 16 wherein the at least one qualitative factor includes at least one present qualitative value and at least one future qualitative value.

22. The software arrangement for facilitating decision-making analysis according to claim 16 wherein the transformation means includes means for integrating the data in accordance with the model, and means for pushing the integrated data onto the results database.

23. The software arrangement for facilitating decision-making analysis according to claim 16 wherein the input database includes a qualitative database and the results database includes a quantitative database and a modified database.

24. The software arrangement for facilitating decision-making analysis according to claim 16 wherein the transformation means includes updating means for dynamically updating the results database upon modifications in the data and the model.

25. The analytic decision-making and optimization system according to claim 16, wherein the interface means provides for establishing a model having factors including weighting factors, scoring factors and switch factors.

26. The software arrangement for facilitating decision-making analysis according to claim 16 wherein the interface is further provided with means for displaying the at least one decision value and means for animating changes in the decision value over a period of time.

27. The software arrangement for facilitating decision-making analysis according to claim 16 further comprising means for displaying the at least one alternative decision value and means for animating changes in the alternative decision value over a period of time.

28. The software arrangement for facilitating decision-making analysis according to claim 16 wherein the interface means permits a user to activate the transformation means.

29. The software arrangement for facilitating decision-making analysis according to claim 17 wherein a bubble on the bubble chart is a point.

30. A software arrangement for facilitating decision-making analysis and for use with a computer in a network comprising:
an input database means for storing data comprising at least one qualitative factor;
a results database means for storing results and at least one decision value;
an interface means for entering the data into the input database means and for establishing a model based on the data; and
transformation means for transforming the data in accordance with the model, for pushing the transformed data into the results database, thereby calculating the results and the at least one decision value and thereby forming at least one scenario, wherein the at least one decision value is calculated using data including at least one qualitative factor;
wherein the interface is further provided with means for reviewing the at least one scenario and for modifying the model and the data including at least one qualitative factor;
wherein the transformation means is further provided with means for updating an alternative results and at least one alternative decision value and thereby forming at least one alternative scenario; and
wherein the interface is further provided with means for comparing the at least one scenario and the at least one alternative scenario; and wherein
the interface means includes means for communicating over the network, for receiving network data, for entering the network data into the input database means and for collecting consensus information over the network for establishing which network data is incorporated into the model.

31. A system for executing a computer program for facilitating decision making analysis, the system comprising:
a memory device for storing the computer program thereon; and
a processor which
enters data and stores the data including at least one qualitative factor;
provides an interface for a user to establish a model based on the data;
transforms the data in accordance with the model and stores the results of the transformation, thereby calculating at least one decision value and forming at least one scenario, wherein the at least one decision value is calculated using data including at least one qualitative factor;
provides an interface for a user to review the at least one scenario and to modify the model and the data including at least one alternative qualitative factor;
transforms the modified data in accordance with the model and stores the modified results of the transformation, thereby calculating at least one alternative decision value and forming at least one alternative scenario, wherein the at least one alternative decision value is calculated using modified data including the at least one qualitative factor; and
provides an interface for a user to compare the at least one scenario and the at least one alternative scenario.
